(19) United States
(12) Patent Application Publication
(10) Pub. No.: US 2001/0025864 A1
(43) Pub. Date: Oct. 4, 2001

(54) Method and installation for dispensing a flowable material

(76) Inventor: Thomas Meyer, Haemikon (CH)

Correspondence Address: BROWDY AND NEIMARK, P.L.L.C., 624 NINTH STREET, NW, SUITE 300, WASHINGTON, DC, 20001-5303, US

(21) Appl. No.: 09/774,003

(22) Filed: Jan. 31, 2001

Related U.S. Application Data
(63) Continuation-in-part of application No. 09/253,752, filed on Feb. 22, 1999, now abandoned.

(30) Foreign Application Priority Data
Mar. 16, 1998 (CH) 1998 0624/98

(51) Int. Cl. G01F 11/00; B67B 7/00; B67D 5/62

(52) U.S. Cl. 222/261; 222/262; 222/263; 222/386; 222/1; 222/146.5; 222/405; 277/646; 277/436; 222/105

(57) ABSTRACT

A method and an installation for dispensing a flowable material. The material (11) is contained in a sleeve 60 positioned in a container (12) underneath a follower plate (36). The follower plate (36) is moved into the container (12) and in the process the material (11) is dispensed via a conduit system. On its contour, the follower plate (36) has a sealing element (50) which can be displaced between a sealing position and a retracted position. In the sealing position this sealing element (50) rests against the inner container surface (16) and constitutes a sealing device. In the retracted position the sealing element (50) is spaced apart from the inner container wall (16) and, together with the latter, delimits an opening (50) for venting the space underneath the follower plate (36).

### FIELD OF THE INVENTION

The invention relates to a method for dispensing a flowable material from a container, wherein the material is enclosed in the container by means of a follower plate, which is matched to the shape of the inner container surface, wherein the space between the material and the follower plate is vented and the material is removed from the container by displacing the follower plate, while the follower plate sealingly rest against the inner container surface via a sealing element, wherein the space below the follower plate is filled with air and the follower plate is retracted out of the at least approximately empty container. The invention further relates to an installation for dispensing a flowable material.

### BACKGROUND OF THE INVENTION

A flowable material which, within the scope of the present specification, is understood to include liquids of any arbitrary and in particular temperature-dependent viscosities, therefore also pastes and granulated materials, usually is delivered to the user in a barrel, for example, which generally has a wide container opening at the top. In this case the material can already be flowable or still solid, wherein it is necessary to liquefy materials delivered in a solid or highly viscous state prior to their removal from the container, generally by the supply of heat. The opened container is arranged in a device, together with which it constitutes an installation of the type mentioned at the outset for dispensing the material. To this end a so-called follower plate, whose exterior contour corresponds to the cross section of the inner container surface, is lowered into the container through the container opening Then the material is dispensed from the container by means of the pressure of the follower plate and/or by the action of a conveying pump through a conduit system in order to be brought to the place where it is used, while the follower plate slowly enters the container still further. After the entire material has been removed from the container, except for a small amount possibly remaining, the follower plate is pulled out of the container and the container, which is now at least approximately empty, is replaced by a further, still full container. A sealing device, which causes the follower plate to rest sealingly against the inner container surface, must be provided, so that the material actually does leave the container through the conduit system and does not exit between the inner container surface and the follower plate. The sealing adherence of the follower plate to the inner container wall requires a venting device, by means of which the space underneath the follower plate can be vented for lowering the follower place to the level of the material and can be filled with air for pulling out the follower plate.

The known installation has several disadvantages, in particular in that the material has a tendency to plug up the passages of the venting device.

Another major problem in connection with the dispensation of materials from containers lies in that often the materials are or contain substances which are harmful to the environment. A result of this is that after being emptied, the containers must be subjected to an elaborate cleaning procedure or must be disposed of as hazardous waste, which generally entails large expenses. For this reason containers have been used for some time in which the material to be dispensed is enclosed in a thin, flexible, impermeable sleeve or envelope of, for example, plastic. In this case the sleeve constitutes the inner container wall which comes into contact with the follower plate, or respectively the sealing element of the follower plate. Contamination of the container is prevented, however possibly remaining amounts usually are disposed together with the used sleeve, which is of course a loss of material. The envelope is provided with an envelope opening at the top for dispensing the material, for example it is cut open, and the edge area of the envelope is fixed in place on the outer container surface or on the inner container surface above the follower plate prior to the follower plate being lowered on the material. In connection with conventional installations without non retractable sealing elements, there is always the danger during lowering of the follower plate, that the sleeve could be damaged by the follower plate, because of the following plate lying flush against the sleeve with its sealing element.

### OBJECT AND SUMMARY OF THE INVENTION

It is therefore the object of the invention to propose a method and an installation of the type mentioned at the outset which avoid the above mentioned problems.

In accordance with the invention, in connection with the method the object is attained by means of claim 1, and in connection with the installation by means of claim 7. Preferred further developments of the method in accordance with the invention are defined in claims 2 to 6, preferred exemplary embodiments of the installation in accordance with the invention in claims 8 to 12.

In accordance with the invention, the material is contained in an envelope or sleeve. The full sleeve is brought into the container, and the emptied sleeve with remaining rests of material is removed from the container. The material is dispensed from the sleeve by lowering the follower plate into and within the sleeve.

The sealing device of the follower plate of the installation is designed so that it has a sealing element which can be displaced between a sealing position, and a retracted position wherein the sealing element is used as a ventilating element. In the sealing position, the sealing element rests sealingly against the inner sleeve surface and pesses the sleeve against the inner container surface. In the retracted position, the sealing element together with the inner sleeve surface, delimits the passage of the ventilating device. It has to be understood that retracting the sealing element means either retracting a whole sealing element by mechanical or fluid means or by deflating an inflatable sealing element which is in it's sealing position only when being inflated.

The danger of damaging the sleeve is prevented when using the installation in accordance with the invention with a sealing device having a retractable sealing element. This sealing element is introduced into the container respectively into the sleeve in it's retracted state and is only brought in it's sealing state later, when the sleeve comes into contact with the inner container surface and damage to the envelope cannot occur.

As already mentioned, the material, which must be flowable when it is dispensed, can be delivered in a flowable or a solid form. Solid materials as well as flowable, but highly viscous materials, must be liquefied prior to being dispensed from the container, to which end they are generally heated. Although it would of course be possible to heat the entire container to achieve this, the heat supply preferably takes place via the follower plate, which is made heatable for this purpose. The surface of the follower plate facing the material can be provided with projections, for example ribs, for improving the heat transfer from the follower plate to the material, in particular at the start of the heating process, or respectively while the material is still solid. Follower plates with projections which taper towards their ends are particularly suited for this, since such ribs can enter more easily into the material being heated, but which is still solid. The dispensation of the material from the container can take place by means of the pressure of the follower plate and/or by the action of a conveying pump, as already mentioned.

The materials to be dispensed are often comparatively expensive products. It is therefore necessary not only for ecological, but also economical reasons, to empty the containers completely or least down to the smallest possible remaining amount. In general, this is unsuccessful due to the fact that in most cases the containers do not have purely prismatic shapes and instead have a rounded place at the transition from the lateral container wall to the container bottom, so that the follower plate cannot be lowered down to the container bottom. In addition, usually the follower plates are not flat on their side facing the material and instead are designed to be conical or in some other way concave. Complete emptying of the container becomes even more problematic, if the material to be dispensed must be heated and a follower plate with projections is used for this purpose, since a comparatively large amount necessarily remains between the projections. In connection with a container in which the material has been placed inside an envelope, these problems can be completely avoided by means of an installation in accordance with the invention.

The container is opened in the usual manner and an upper sleeve opening is made in the envelope, whereafter the sleeve edge area is fixed in place on the container. Thereafter the container is emptied to the extent possible by lowering the follower plate, wherein a remaining amount, even of considerable size, is unimportant. Thereafter the sleeve edge area is removed from the container, the sleeve is fixed on the follower plate by means of the sleeve edge area and is pulled out of the container together with the remaining amount by means of the follower plate. The sleeve with the remaining amount can be disposed of separately as hazardous waste, and the container, which is not only completely empty but also clean, can thereafter be reused without any elaborate cleaning.

For ecological as well as economical reasons it is even more advantageous not to dispose of the sleeve with the remaining amount, but instead to bring it over a container which is completely or partially filled and has been opened already, and whose envelope has been provided with the upper envelope opening, and thereafter to make a lower opening in the envelope containing the remaining amount, so that the remaining amount can get into the further container and can be used together with the contents of the latter.

Since in this case the remaining amount does not become hazardous waste, but can be used, it is not necessary to take particular steps for keeping the remaining amount as small as possible. This makes it possible to use follower plates with high projections, and therefore more advantageous heat transfer, for materials which must be heated, something which up to now had been attempted to be avoided in order to minimize the remaining amounts.

The invention will be extensively described in what follows by means of a preferred exemplary embodiment of the installation in accordance with the invention, making reference to the drawings.

### BRIEF DESCRIPTION OF THE DRAWINGS

FIG. 1 represents a lateral view in partial section of an installation in accordance with the invention;

FIG. 2 shows a schematic representation of an inflatable sealing element mounted on the follower plate in the inflated state, or respectively acting as the sealing device, with am inflatable sealing element;

FIG. 3 shows a schematic representation of the inflatable sealing element represented in FIG. 2 in the deflated state, or respectively acting as a ventilating device;

FIG. 4 represents portions of a container with material arranged in an sleeve in the course of liquefying the material, with an inflatable, inflated sealing element;

FIG. 5A represents portions of the container shown in FIG. 4 in the course of removing the sleeve with the remaining amount, with a inflatabele, deflated sealing element;

FIG. 5B represents a detail of FIG. 5A, with a mechanically displaceable sealing element, in retracted position; and

FIGS. 6A to 6C represent schematically the emptying of the sleeve and transfer of the remaining material from the almost emptied sleeve into another sleeve.

### DETAILED DESCRIPTION OF THE PREFERRED EMBODIMENT

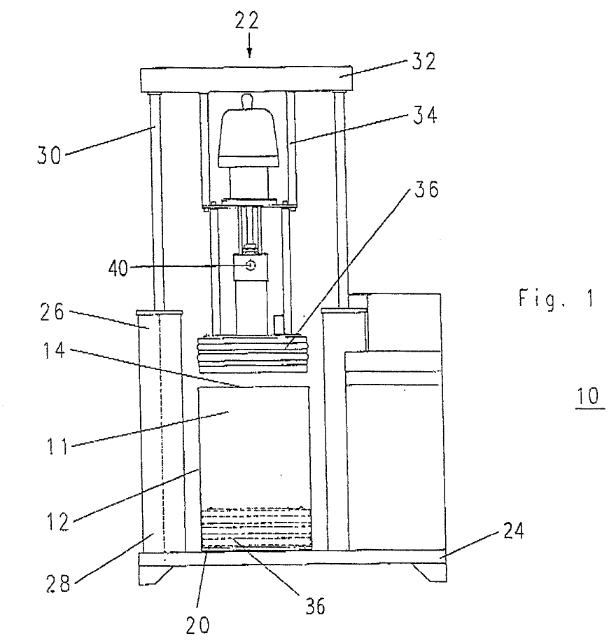

The installation 10 represented in FIG. 1 includes a container 12 having a container opening 14 extending over its clear width, a container wall with an inner container surface 16 and an outer container surface 18, as well as a container bottom 20, and in which the material to be dispensed is contained. The material is contained in a sleeve or envelope 60 which is notv shown in FIGS. 1 to 4, since it is of no major importance for the features which are specified by means of FIGS. 1 to 4.

The installation 10 furthermore comprises a device 22, in which a container 12, which can be exchanged for further containers, is arranged. The device 22 has a structure with a base plate 24 for receiving the container 12, and a superstructure. The superstructure has vertical supports 26 constituted by piston/cylinder units. The lower areas of the piston/cylinder units are cylinders 28, and the upper areas of the piston/cylinder units are piston rods 30, which extend out of the cylinders 28 and are displaceable in relation to the cylinders 28. The upper ends of the piston rods 30 are connected by means of a horizontal yoke 32, on which a follower plate 36 is fastened via actuating rods 34. In the representation in accordance with FIG. 1, the piston rods 30, the yoke 32 and all components of the installation 10 fastened on the yoke 32, in particular the follower plate 36, are in their upper end position. This upper end position is assumed while an emptied container is replaced by a still full container, or respectively prior to the start of dispensing the material 11 in the container 12 and following the dispensation of the material 11, when the follower plate 36 has returned from its lower end position back into its upper end position. Furthermore, in FIG. 1 the follower plate 36 is also represented by dashed lines in its lower end position, in which it is in the vicinity of the container bottom 20. The follower plate 36 takes up this lower end position when the dispensation of the material 11 from the container 12 is finished, but the follower plate 36 has not yet been retracted out of the container 12.

The follower plate 36 has an opening, not represented, through which the material 11 flows off toward the top out of the container 12 by the action of the pressure of the lowering follower plate 36 and/or by the action of a pumping device. The material 11 leaves the installation 10 at a connector 40.

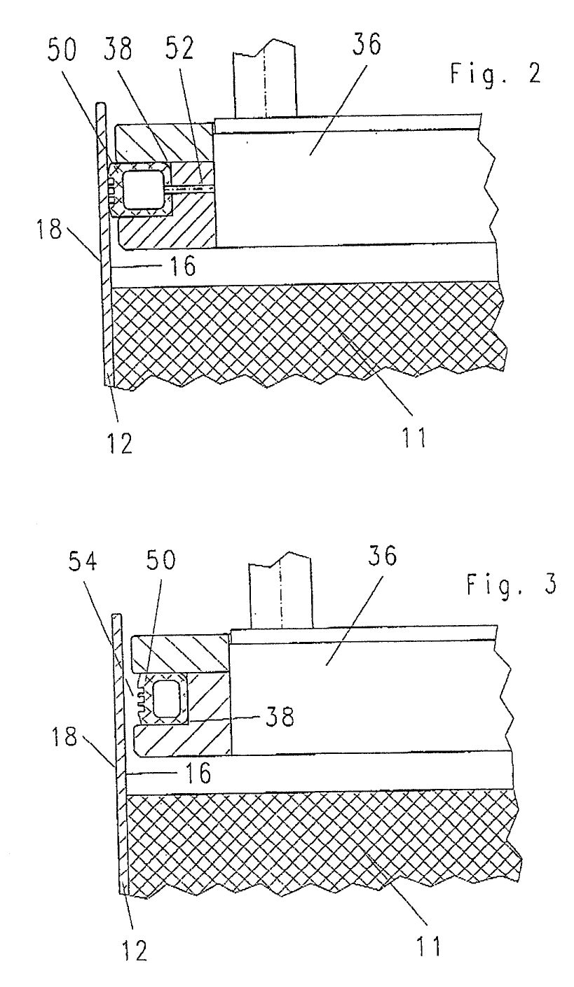

FIGS. 2 and 3 represent an inflatable sealing element as well as the adjoining areas of the inner container surface 16 and the follower plate 36. On its contour, the follower plate 36 has an open chamber 38 facing the inner container surface, in which the inflatable, or respectively inflated sealing element 50 is arranged, which can be charged with pressure via a line 52, 53. FIG. 2 represents the sealing element 50 under pressure, or respectively in the inflated state. In this state the sealing element 50 rests flush against the inner container surface 16 and constitutes a sealing device. While the material 11 is dispensed from the container 12, the sealing element 50 is put under pressure in order to prevent the material 11 to flow off laterally between the inner container surface 16 and the follower plate 36. FIG. 3 shows the sealing element 50 in the deflated state. In this state the sealing element 50 is spaced apart from the inner container surface 16, delimits an opening 54 together with the inner container surface 16 and in this way constitutes a ventilating device for venting the space underneath the follower plate 36 in the course of lowering the follower plate 36 into the container 12 and for letting air into the space underneath the follower plate 36 when the follwer plate is raised.

Adjoining areas of the follower plate 36 and the inner container surface 16 are again represented in FIG. 4. The material 11 is not placed directly into the container 12, but into the flexible impermeable envelope or sleeve 60 which has been mentioned above and which, in this case, functionally constitutes the inner container surface 16.1. The sleeve 60 has been provided with an upper sleeve envelope and has been fixed in place by means of a suitable fastening element 64 on the outer container surface 18 with the envelope edge 62, which had been created in the process. The inflatable sealing element 50 is only provided with pressure after the follower plate 36 has been placed into the container 12 Because of this the sleeve 60 is radially pushed against the inner container surface 16 at least in the area of the follower plate 36, so that the sealing element 50 rests flush against the envelope 60 constituting the inner container surface 16.1. The follower plate 36 can now be lowered without damaging the sleeve 60.

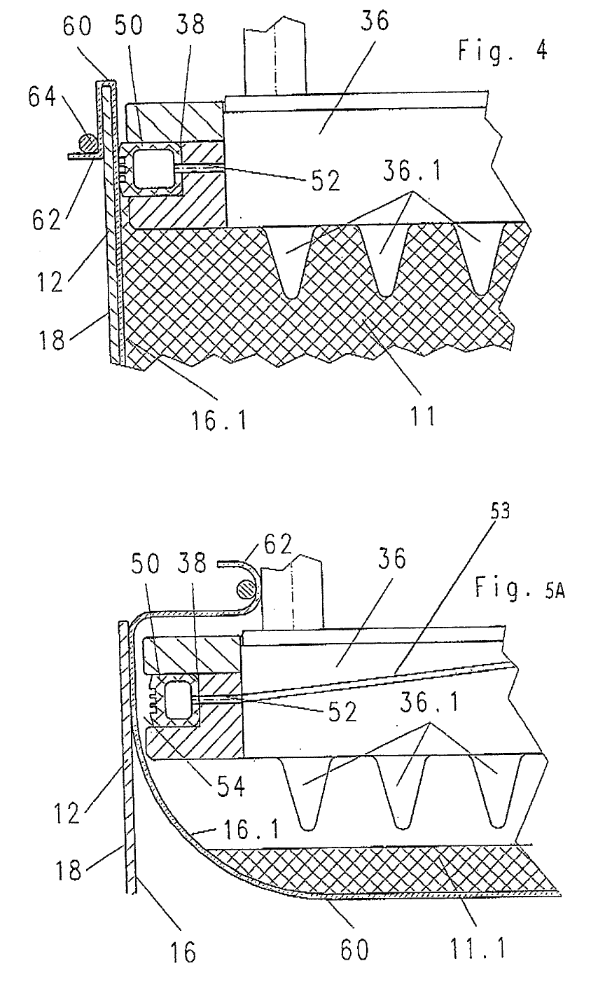

FIG. 5A represents the arrangement in accordance with FIG. 4, but at the conclusion of dispensing the material 11. The envelope 60 contains only a remaining amount 11.1 of the material 11. Now the envelope edge 62 of the upper envelope opening is no longer fixed in place on the outer container surface 18, but instead on the upward facing portion of the follower plate 36. The inflatable sealing element 50 has been deflated. Now the sleeve 60, along with the remaining amount 11.1 in it, can be easily removed from the container 12 by lifting the follower plate 36. As soon as the emptied container 12 has been exchanged for another, not yet emptied container, a lower envelope opening is made in the sleeve 60, through which the remaining amount 11.1 can flow off into the further container.

FIG. 5B represents a detail of the arrangement of FIG. 5A, with the difference that sealing element 50 is not inflatable and deflatable but mechanically displaceable by means of a conical element 70 in the follower plate 36 which can move upwards and downwards in direction of arrow A so as to enlarge or diminish the diameter of the sealing element 50.

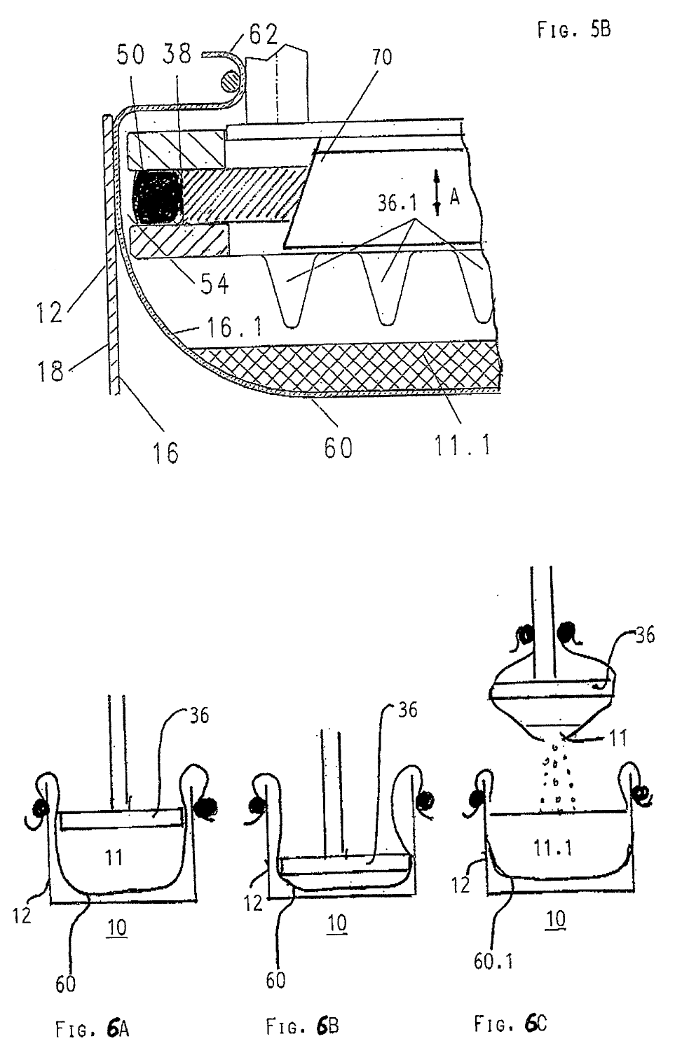

FIGS. 6A to 6C show how sleeve 60 is emptied and how remaining material 11 is transferred with and from the sleeve 60 into a further sleeve 60.1 filled with material 11.1, which is in general identical with material 11. Sleeve 60.1 is containes in a container as well. The container containing further sleeve 60.1 may be the same container as used before or a further container. The remaining amount of material 11 amount of sleeve 60 may of course also be transferred into another recipe. FIG. 6A shows the container 12 with the sleeve 60 fastened to the outer container surface and filled with material 11 to be dispensed and with the follower plate 36 in an upper position. FIG. 6B shows the container 12 with the sleeve 60 still fastened to the outer container surface but containing only a remaining amount of material 11 and with the follower plate 36 in an middle position. FIG. 6C shows the sleeve 60 with the remaining amount of material 11 fastened to the follower plate 36 in a high position above a container with the further sleeve 60.1 filled with the material 11.1; an lower opening has been made in sleeve 60 so that the remaining material 11 can flow or drip in further sleeve 60.1.

The follower plate 36 represented in FIGS. 4, 5A and 5B can be heated and has projections 36.1 in the shape of tapering ribs on its surface facing the material 11, which improve the heat transfer from the follower plate 36 to the material 11. This follower plate 36 provided with the projections 36.1 is practical in cases in which the viscosity of the material 11 must be increased by raising its temperature, or in which the material 11 has been provided as a solid material and must be liquefied prior to being dispensed. Since, thanks to the envelope 60, the remaining material 11.1 does not become waste, but is recycled, the height of the projections 36.1 of the follower plate 36, which determines the amount of the remaining material 11.1, can be comparatively large, because of which the heating process is improved and the length of heating the material 11 is minimized.

What is claimed is:

1. A method for dispensing a flowable material from a container, wherein
a flexible impermeable sleeve having an upper opening delimited by an edge area and containing the material is positioned in the container
the opening edge area is releasably fastened to the outer container surface,
a follower plate, which is matched to the shape of the inner container surface is brought into the envelope above the material, so that the material is enclosed by the sleeve and by the follower plate,
the opening border area of the sleeve is released from the outer container surface and releasably fastened to the follower plate,
the space between the material and the follower plate is vented or ventilated,
the follower plate is brought into sealing contact with the inner sleeve surface by bringing a sealing element of the follower plate in a sealing position, hereby pressing the sleeve against the inner container surface,
the material is removed from the sleeve by displacing the follower plate,
the space in the envelope below the follower plate is vented or ventilated by retracting the sealing element from it's sealing position,
the follower plate with the at least approximately empty sleeve is retracted out of the container.

2. The method in accordance with claim 1, wherein the sealing element is brought into sealing contact and retracted from sealing contact by mechanical or fluid means.

3. The method in accordance with claim 1, wherein the sealing element, which is designed to be inflatable, is brought into sealing contact by being inflated and retracted from sealing contact by being deflated.

4. The method in accordance with at least one of claims 1 to 3, wherein the material in the sleeve positioned in the container is made more flowable by the application of heat.

5. The method in accordance with at least one of claims 1 to 4, wherein the material is dispensed from the sleeve positioned in the container by means of the pressure of the follower plate and/or the action of a pump.

6. The method in accordance with at least one of claims 1 to 5, wherein
the sleeve removed from the container and containing a remaining amount of material is positioned above a recipe, preferably a further sleeve contained in a container, the further sleeve preferably being filled with material, and
a lower sleeve opening is created in the envelope in order to place the remaining amount of the material into the further envelope.

7. An installation for dispensing a flowable material, with
a container having a container opening,
a flexible, impermeable sleeve containing the material, which sleeve is positioned in the container through the container opening,
said sleeve having an upper opening with an edge area, which can be releasably fastened to the outer container surface,
said follower plate being matched to the shape of the inner container surface and being slidable into, within and out of the sleeve,
a sealing device on said follower plate, with a circumferential sealing element,
a ventilating device with an opening being provided for ventilating the space in the sleeve located underneath the follower plate,
said sealing element, for the purpose of mutual sealing between the inner sleeve surface and the follower plate being displaceable between
a sealing position, wherein, for the purpose of mutual sealing between the inner sleeve surface and the follower plate, the sealing element rests sealingly against the inner envelope surface and
a retracted position, wherein, it delimits, together with the inner envelope surface, said opening.

8. The installation in accordance with claim 7, wherein said sealing device comprises mechanical or fluid means for displacing said sealing element.

9. The installation in accordance with claim 7, wherein said sealing element is inflatable, and said sealing device comprises a pressure source and a pressure conduit connecting the pressure source with the sealing element.

10. The installation in accordance with at least one of claims 7 to 9, wherein the follower plate can be heated in order to increase the flowability of the material by the supply of heat, wherein preferably the surface of the follower plate provided for contact with the material is provided with possibly tapering projections, in particular ribs, in order to improve the heat transfer from the follower plate to the material.

11. The installation in accordance with at least one of claims 7 to 101 wherein a device is comprised for displacing the follower plate and, if required, a conveying pump for dispensing the material under pressure out of the container.

12. The installation in accordance with at least one of claims 7 to 11, wherein the sleeve with a remaining amount of material is releasably fastened on the follower plate, and can be removed together with the follower plate from the container in order to be provided, preferably above a further recipe, preferably a further envelope contained in a container, with a lower envelope opening, through which the remaining amount can be brought into the recipe.
